(19) United States
(12) Patent Application Publication
(10) Pub. No.: US 2019/0100272 A1
(43) Pub. Date: Apr. 4, 2019

(54) EXTENDABLE RUNNING BICYCLE

(71) Applicant: SMART TRIKE MNF PTE LTD., Singapore (SG)

(72) Inventor: Yoram Baron, Moshav Nir Israel (IL)

(21) Appl. No.: 16/132,563

(22) Filed: Sep. 17, 2018

Related U.S. Application Data
(60) Provisional application No. 62/567,812, filed on Oct. 4, 2017.

(51) Int. Cl. B62K 13/08; B62K 9/00; B62K 15/00; B62H 7/00

(52) U.S. Cl. CPC B62K 13/08; B62H 7/00; B62K 15/00; B62K 9/00

(57) ABSTRACT

The present invention relates to an extendable bicycle transformable from a running bicycle into a pedaling bicycle comprising: (a) a front wheel; (b) a fork for rotatably holding said front wheel; (c) an extendable handlebar, connectable to said fork, for steering said front wheel; (d) a head tube for turnably holding said fork; (e) a rear wheel, having an axis, and capable of rotating around its own axis; (f) an extendable chair; (g) two detachable pedal arms having one pedal each; (h) an extendable frame, attached to said head tube, which supports said chair and said pedal arms.

### FIELD OF THE INVENTION

The present invention relates to the field of riding vehicles. More particularly, the invention relates to an extendable riding vehicle.

### BACKGROUND OF THE INVENTION

Balancing and coordination skills are essential for learning how to ride a bicycle. Nevertheless, acquiring these skills is not an easy task for beginner cyclists, especially young children. A known approach for achieving bicycle riding skills is to use a set of training wheels, which is attached to the bicycle's rear wheel assembly. However, since there are many different bicycle models and sizes for the beginner, the manufacturing and stocking of each specific type of training wheel device for said models and sizes is costly.

Certain training methods involve the providing of a training scooter which does not have pedals. A beginning cyclist can learn to balance and coast on these training scooters, but must switch to a different bicycle with pedals to learn balancing and coasting while peddling. The switching to a different bicycle which has a different feel and weight is believed to inhibit the learning process. Additionally, these training scooters do not position the beginning cyclist's legs to approximate the position of the legs when learning to balance and coast while peddling.

US 2015/0035248 describes a riding vehicle transformable from a running bicycle into a pedaling bicycle which comprises a frame for pivotally holding its two wheels, and supporting a handle bar and a chair. The described vehicle also comprises two foldable pedals which can fold into the frame of the bicycle. Nevertheless, the described vehicle is heavy to operate.

U.S. Pat. No. 7,798,513 describes an apparatus for training a beginning cyclist to ride a bicycle, which includes providing a bicycle with detachable pedals and at least a portion of the crank arms, and attaching guard shields on the remaining portions of the crank arms. The described training bicycle can be converted to a training mode where at least a portion of the crank arms and pedals are removed. The crank shields protect the cyclist's legs and feet from getting snagged during the balancing step of learning. Nevertheless, the described apparatus is inefficient.

Is would therefore be desired to propose a system void of the problems discussed above.

### SUMMARY OF THE INVENTION

It is an object of the present invention to provide a riding vehicle that can be transformed from a running bicycle into a pedal bicycle.

It is another object of the present invention to provide a bicycle that can be extended from a small bicycle for smaller cyclists into a larger bicycle for bigger cyclists.

It is still another object of the present invention to provide a bicycle that can be transformed from one arrangement to another arrangement for accommodating the growing rider.

It is still another object of the present invention to provide a bicycle that can be easily and simply transformed from one arrangement to another.

Other objects and advantages of the invention will become apparent as the description proceeds.

The present invention relates to an extendable bicycle transformable from a running bicycle into a pedaling bicycle comprising: (a) a front wheel, having an axis, and capable of rotating around its own axis; (b) a fork for rotatably holding said front wheel; (c) an extendable handlebar, connectable to said fork, for steering said front wheel; (d) a head tube for turnably holding said fork; (e) a rear wheel, having an axis, and capable of rotating around its own axis; (f) an extendable chair; (g) two detachable pedal arms having one pedal each; (h) an extendable frame, attached to said head tube, which supports said chair and said pedal arms comprising: (i) an outer tube; (j) an inner tube a clamp for fastening said outer tube to said inner tube; (k) wherein said outer tube and said inner tube have the same non-circular cross-sectional shape.

In one embodiment, the non-circular cross-sectional shape of the outer tube and the inner tube has an angle of about 76 degrees.

In one embodiment, the non-circular cross-sectional shape of the outer tube and the inner tube has an angle between 60-90 degrees.

Preferably, the extendable frame can be extended by pulling the inner tube from the outer tube.

### BRIEF DESCRIPTION OF THE DRAWINGS

In the drawings:

FIG. 1 is a diagram, from a left side view, of the extendable bicycle in its running bike arrangement, according to an embodiment of the invention.

FIG. 2 is a diagram, from an upper view, of the extendable bicycle in its running bicycle arrangement, according to an embodiment of the invention.

FIG. 3 is a diagram, from a left side view, of the extendable bicycle in its pedal bike arrangement, according to an embodiment of the invention.

FIG. 4 is a diagram, from a left side view, of the extendable bicycle in its partially extended mode, according to an embodiment of the invention.

FIG. 5 is a diagram, from a right-side view, of the extended bicycle in its extended mode, according to an embodiment of the invention.

FIG. 6 is an enlarged diagram, of the lever, according to an embodiment of the invention.

FIG. 7 is an enlarged diagram, from a right-side view, of part of the bicycle in its extended mode, according to an embodiment of the invention.

FIG. 8 is an enlarged diagram, of a cross sectional view of the outer tube, according to an embodiment of the invention.

FIG. 9 is an enlarged diagram, of the clamp with a lever, according to an embodiment of the invention.

FIG. 10 is an enlarged diagram, of the knob of the clamp, according to an embodiment of the invention.

### DETAILED DESCRIPTION OF PREFERRED EMBODIMENTS

Hereinafter, parts, elements and components that are depicted in more than one figure are typically referenced by the same numerals.

The terms of “front”, “rear”, “down”, “up”, “bottom”, “upper”, “horizontal”, “vertical” or any reference to sides or directions are used throughout the description for the sake of brevity alone and are not meant to be limiting in any way.

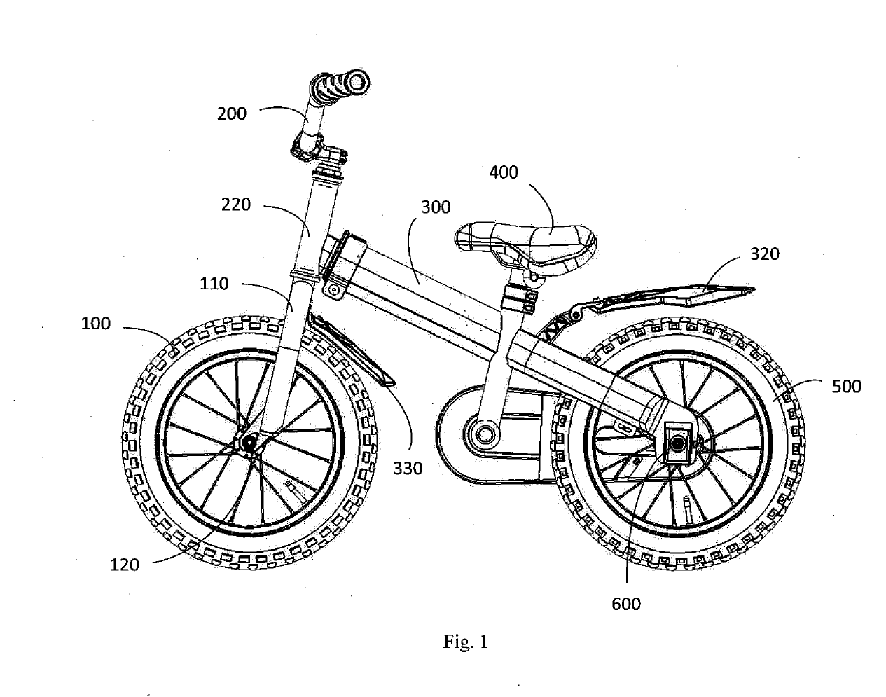

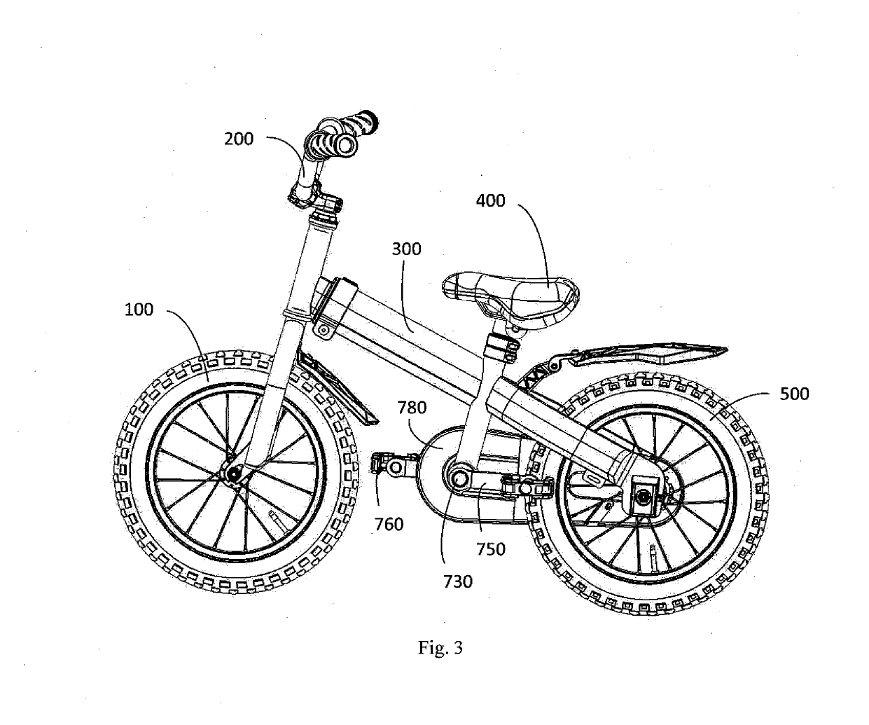

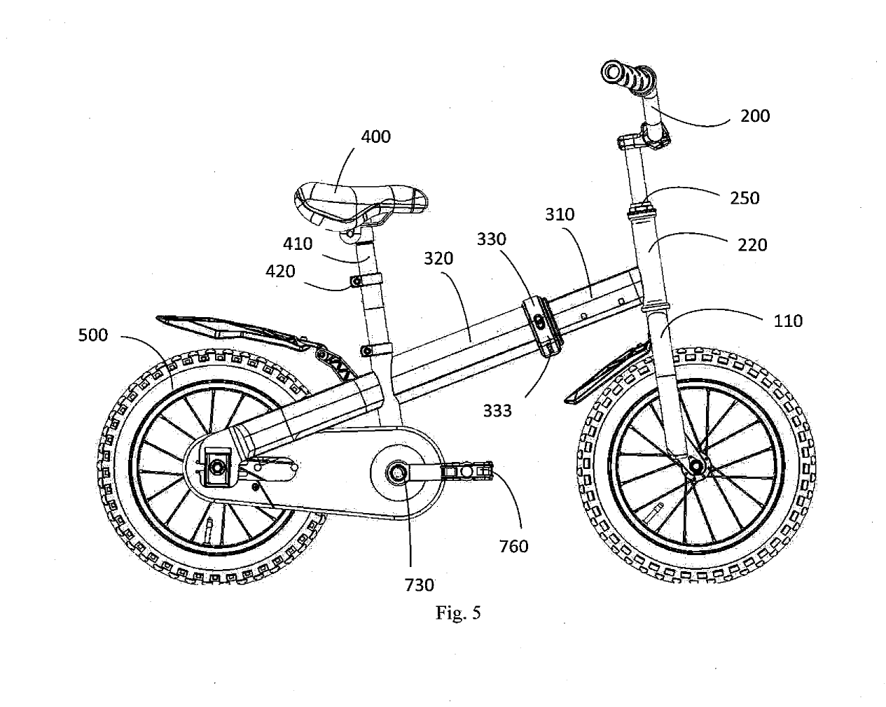

FIG. 1 is a diagram, from a left side view, of the extendable bicycle in its running bike arrangement, according to an embodiment of the invention. In this arrangement, the detachable pedals, which will be described in greater detail in relations to FIG. 3, are not attached to the bicycle in order to eliminate any interference with the legs and feet of the rider, while he is running with the running bike. Thus, the beginning cyclist may use the bicycle as a running bike for learning to balance and coast. The extendable bicycle may have an extendable frame 300 which may hold the rear wheel axle 600 at its rear side. The rear wheel axle 600 may rotatably hold the rear wheel 500 and allow it to rotate. A head tube 220 may be attached to the front end of extendable frame 300, where the head tube 220 may turnably hold the stem of fork 110. The fork 110 may rotatably hold the front wheel axle 120. The front wheel axle 120 may rotatably hold the front wheel 100 and allow it to rotate. The stem of the fork 110, or the fork 110 itself, may be connected to extendable handlebar 200 by one or more connecting tube(s). Thus, the handlebar 200 may be used in order to control the turning right and left of the front wheel. Any number of tubes, pipes, or bars, may connect the handle bars 200 to the stem of fork 110, as long as the handlebar 200 may be used for controlling the rotating right and left of the front wheel 100, i.e. controlling the steering of the bicycle. The frame 300 may also support a chair 400 where its height may be extendable, as describe in greater detail in relations to FIG. 5.

In one embodiment, a rear mudguard 320 may be added and may be attached to the frame 300, as depicted in FIG. 1 for example. In one embodiment, a front mudguard 330 may be added and may be attached to the fork 110. In one embodiment, a flash light or a front light reflector may be added. In one embodiment, a flash light or a back-light reflector may be added.

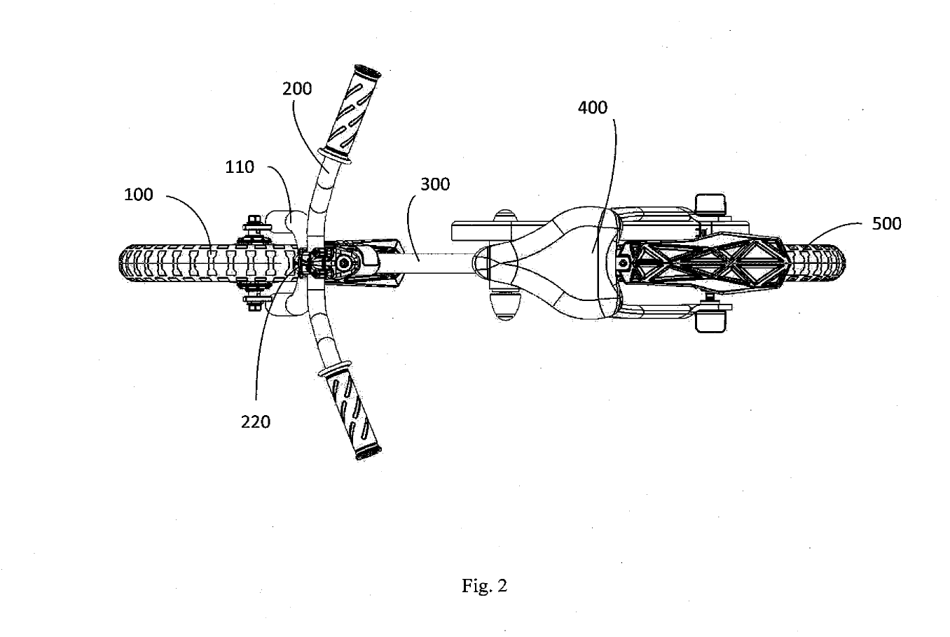

FIG. 2 is a diagram, from an upper view, of the extendable bicycle in its running bicycle arrangement, according to an embodiment of the invention. As described in relations to FIG. 1, the extendable bicycle may have an extendable frame 300 which may be attached to the head tube 220. The head tube 220 may turnably hold the fork 110. This practice of running and riding can teach the rider to balance himself on the bicycle easily and comfortably.

FIG. 3 is a diagram, from a left side view, of the extendable bicycle in its pedal bike arrangement, according to an embodiment of the invention. In this arrangement the pedal arms such as pedal arm 750 are attached to the main axle 730 by any known means such as nut over screw, clamp, clincher, or any other means. The axle 730 may be rotatably held by the frame 300 of the bicycle or by any other connecting means. In one embodiment the axle 730 is rotatably held by a bearing which is held by the frame 300. The two detachable pedal arms may each have one pedal attached at its end, such as pedal 760, for allowing the rider to pedal the bicycle. Thus, when the rider wishes to use the bicycle as a regular pedaling bike he may attach the pedal arms to the main axle 730 and start pedaling the bicycle. Thus, the rider can ride the bicycle by rotating the pedals which in turn rotate the main axel 730, which rotates the wheel 500 using a revolving chain (not shown) which may be located inside the framework 780, similar to the workings of a prior art bicycle. In one embodiment the ends of the main axle 730 may be covered by caps when the pedal arms are detached, such as when the bicycle is in running bike arrangement. Thus, in some embodiments the user is required to remove the caps off the main axle 730 before attaching the pedal arms to the main axle 730.

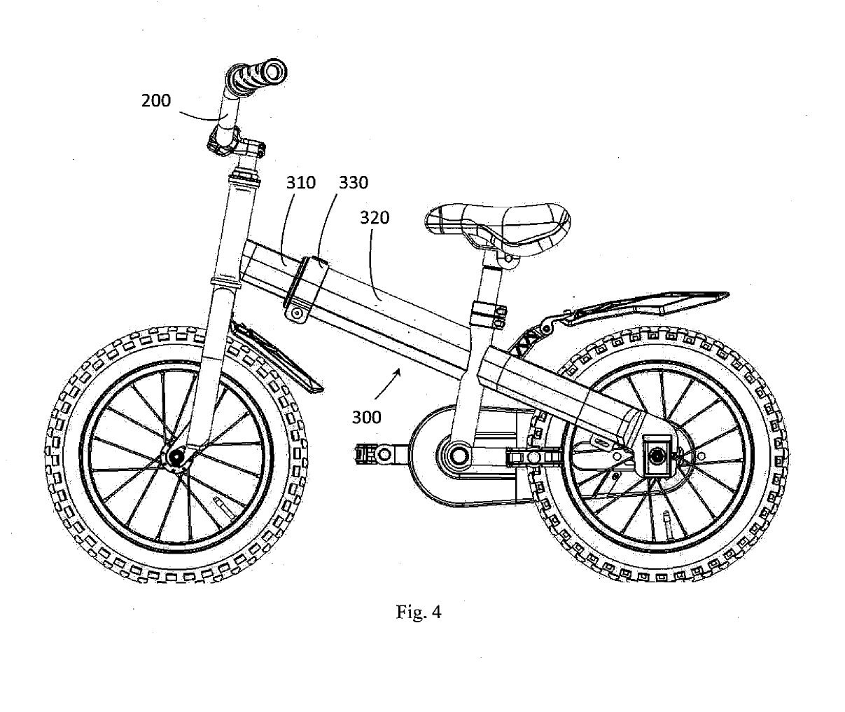

FIG. 4 is a diagram, from a left side view, of the extendable bicycle in its partially extended mode, according to an embodiment of the invention. In this mode the frame 300, described in relations to FIG. 3, may be partially extended in order to accommodate the growing user. Thus, the frame 300 may be extended by extending the inner tube 310, of the frame 300, from the outer tube 320, of the frame 300. In some embodiments, the inner tube 310 is held and fastened, by a clamp 330, to the outer tube 320. In some embodiments, there may be more than one partially extended mode, such as 2 possible partially extended modes, where the frame may be extended even further, than described, for accommodating a taller rider.

FIG. 5 is a diagram, from a right-side view, of the extended bicycle in its extended mode, according to an embodiment of the invention. In this diagram the bicycle is in its running bike arrangement similar to the arrangement described in relations to FIG. 4, however, in this arrangement the bicycle is fully extended to accommodate a taller rider. In this diagram the chair 400 has been pulled up to accommodate the taller rider. The chair 400 may be fastened to one or more tubes, pipes, or bars, such as tube 410 for telescopically extending the height of the chair 400. The tubes of the chair 400 may have one or more chair clamp(s), such as chair clamp 420, for holding and fastening the connection between the tubes of the chair. Other fastening means, for fastening the tubes of the chair 400 may be used. For example, once the clamp 420 has been loosened the chair 400 may be pulled upward and fitted for the taller rider's convenience. After fitting the chair 400 at the right height, the clamp 420 may be fastened again. The horizontal length of the bicycle may be extended as well by pulling lever 333 and loosening clamp 330. Once clamp 330 has been loosened the inner tube 310 may be pulled from the outer tube 320 and adjusted according to the needs of the rider. After the right length is set the clamp 330 may be fastened again using lever 333.

In one embodiment, the extending feature of the bicycle is used for accommodating the growing user. Thus the bicycle may be bought initially for a rider who is a child and changed periodically in relations to the rider's growth. For example the chair 400, as described in relations to FIGS. 1-5 can be pulled up and extended to accommodate the growing rider. As described, the chair 400 can extended and secured in the extended mode. Thus, the chair 400 may be held upward and fitted in one configuration of any number of extended configurations for the growing rider. In other embodiments other extending means may be used for extending the chair's height. The handle 200 may be extended as well by loosening the nuts 250 and pulling the handle 200 upwards from inside the head tube 220. In other embodiments other extending means may be used for extending the handle's height. The horizontal length of the bicycle may be extended as well by pulling lever 333 and loosening clamp 330. Once clamp 330 has been loosened the inner tube 310 may be pulled from the outer tube 320 and adjusted according to the needs of the growing rider. After the right length is set the clamp 330 may be fastened again using lever 333. In other embodiments other extending means may be used for extending the length between the axis of the front wheel and the axis of the back wheel. Thus, the bicycle may be changed from a first configuration which can accommodate a shorter rider to a second configuration which can accommodate a taller rider.

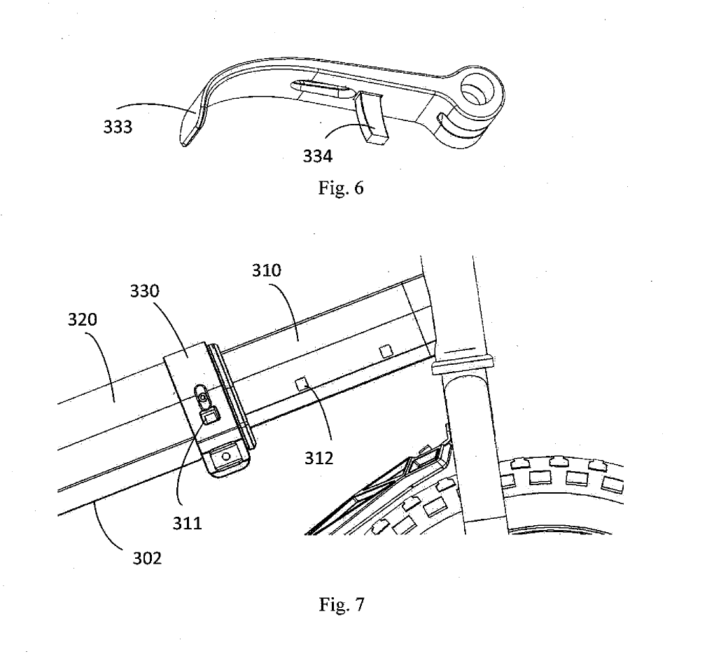

FIG. 6 is an enlarged diagram, of the lever 333, according to an embodiment of the invention. The lever 333, as described in relations to FIG. 5, may have a protrusion 334 for fastening the tubes of the frame together, as will described in detail in relations to FIG. 7.

FIG. 7 is an enlarged diagram, from a right-side view, of a part of the bicycle in its extended mode, according to an embodiment of the invention. In this diagram the lever 333, as described in relations to FIG. 6, has been removed for the sake of brevity. In this embodiment the outer tube 320 may have a hole such as hole 311 where the protrusion from the lever 333 may enter, when closed. In this embodiment the inner tube 310 may have 2 or more holes, such as hole 312, which may correspond to hole 311 where the protrusion from the lever 333 may enter for fastening the inner tube 310 to the outer tube 320 in preset extensions. Thus, the frame of the bicycle may be extended by opening the lever 333, extending the inner tube 310 from the outer tube 320 until one of the holes of the inner tube 310 corresponds to the hole of the outer tube 320, and then closing the lever 333 while pushing the protrusion 334 into both holes and fastening the inner tube 310 to the outer tube 320.

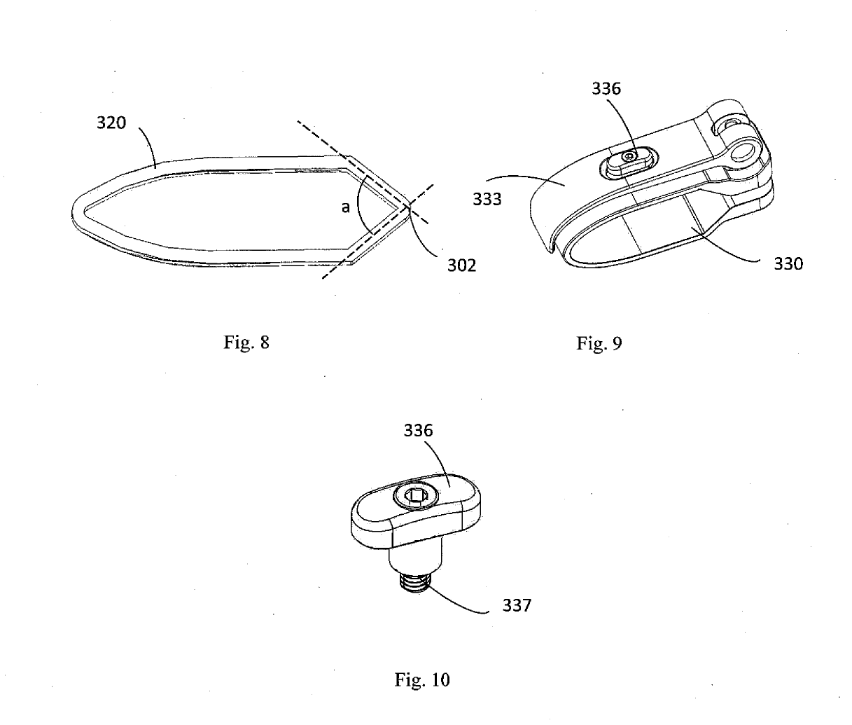

FIG. 8 is an enlarged diagram, of a cross sectional view of the outer tube 320, according to an embodiment of the invention. In one of the embodiments the inner tube 310 and the outer tube 320, as described in relations to FIG. 7, both have the same non-circular cross-sectional shape for the purpose of eliminating the possibility of rotation of the inner tube 310 in relations to the outer tube 320. In one embodiment, the inner tube 310 and the outer tube 320 both have an angle a at their bottom part 302 for the purpose of eliminating the possibility of rotation of the inner tube 310 in relations to the outer tube 320. In one embodiment the angle a is about 76 degrees. In another embodiment the angle a is between 60-90 degrees. In other embodiments, other shapes and angles may be possible as well.

FIG. 9 is an enlarged diagram, of the clamp 330 with lever 333, according to an embodiment of the invention. In this embodiment the clamp 330 may also have a security knob 336 which may be turned in order to fasten the lever 333 to the clamp 330. Thus, when the knob 336 is turned sideways the lever may not be pulled and opened accidentally.

FIG. 10 is an enlarged diagram, of the knob 336 of clamp 330, according to an embodiment of the invention. In this embodiment the security knob may have a screw like bottom 337 for fastening the knob into a specifically designed screw hole (not shown) in the outer tube 320. As described in relations to FIG. 9, the security knob 336 may be turned sideways in order to fasten the lever 333 to the clamp 330. Thus, when the knob 336 is turned sideways the lever may not be pulled and opened accidentally. However, when the rider wishes to extend, or shorten, the length of the frame of the bicycle, he may be required to turn the knob 336 to its straight position, as depicted in FIG. 9, and then pull out the lever 333 and then extend, or shorten, the length of the frame after which he may close the lever 333 and turn the knob 336 sideways again for fastening the desired length of the frame.

In one embodiment parts of the extendable bicycle may be made from magnesium alloy or from more than one magnesium alloy. The magnesium alloy may be any one of the known magnesium cast alloys such as: AZ63, AZ81, AZ91[3], AM50, AM60, ZK51, ZK61, ZE41, ZC63, HK31, HZ32, QE22, QH21, WE54, WE43, or Elektron 21. The magnesium alloy may be any one of the known magnesium wrought alloys such as: AZ31, AZ61, AZ80, Elektron 675, ZK60, M1A, HK31, HM21, ZE41, ZC71, ZM21, AM40, AM50, AM60, K1A, M1, ZK10, ZK20, ZK30, or ZK40.

In one embodiment parts of the extendable bicycle may be made from aluminum alloy or from more than one aluminum alloy. The aluminum alloys may be alloys in which aluminum (Al) is the predominant metal. The alloying elements may be copper, magnesium, manganese, silicon, tin, zinc, or any other known alloying element. The aluminum alloy may be a casting alloy and wrought alloy, or any combination of the subdivided categories of the alloys such as heat-treatable and non-heat-treatable. In one embodiment the cast aluminum alloy system may be a Al—Si, where the high levels of silicon (4.0-13%) contribute to give good casting characteristics.

In one embodiment parts of the extendable bicycle may be made from titanium alloy or from more than one titanium alloy. The Titanium alloys may be metals that contain a mixture of titanium and other chemical elements, such as small amounts of aluminum and vanadium. The titanium alloys may be Alpha alloys, Near-alpha alloys, Alpha and beta alloys, Beta and near beta alloys, or any other known alloys. The titanium alloys may contain beta stabilizers (such as molybdenum, silicon and vanadium) to allow them to maintain the beta phase when quenched, and which can also be solution treated and aged to improve strength, such as: Ti-10V-2Fe-3Al, Ti-29Nb-13Ta-4.6Zr, Ti-13V-11Cr-3Al, Ti-8Mo-8V-2Fe-3Al, Beta C, Ti-15-3.

In one embodiment the parts of the extendable bicycle may be made from any combination of the alloys described above.

While the above description discloses many embodiments and specifications of the invention, these were described by way of illustration and should not be construed as limitations on the scope of the invention. The described invention may be carried into practice with many modifications which are within the scope of the appended claims.

1. An extendable bicycle transformable from a running bicycle into a pedaling bicycle comprising:
a front wheel, having an axis, and capable of rotating around its own axis;
a fork for rotatably holding said front wheel;
an extendable handlebar, connectable to said fork, for steering said front wheel;
a head tube for turnably holding said fork;
a rear wheel, having an axis, and capable of rotating around its own axis;
an extendable chair;
two detachable pedal arms having one pedal each;
an extendable frame, attached to said head tube, which supports said chair and said pedal arms comprising:
an outer tube;
an inner tube
a clamp for fastening said outer tube to said inner tube;
wherein said outer tube and said inner tube have the same non-circular cross-sectional shape.

2. A bicycle according to claim 1 where the non-circular cross-sectional shape of the outer tube and the inner tube has an angle of about 76 degrees.

3. A bicycle according to claim 1 where the non-circular cross-sectional shape of the outer tube and the inner tube has an angle between 60-90 degrees.

4. A bicycle according to claim 1, where the extendable frame can be extended by pulling the inner tube from the outer tube.
